(19) United States
(12) Patent Application Publication
(10) Pub. No.: US 2008/0245667 A1
(43) Pub. Date: Oct. 9, 2008

(54) Electromembrane Process and Apparatus

(76) Inventors: Christopher Peter Jones, Swindon (GB); Peter James Mawle, Bath (GB)

Correspondence Address: The BOC Group, Inc., 575 MOUNTAIN AVENUE, MURRAY HILL, NJ, 07974-2082, US

(21) Appl. No.: 10/592,972

(22) PCT Filed: Mar. 9, 2005
(86) PCT No.: PCT/GB2005/000875

§ 371 Date: Sep. 15, 2006

(30) Foreign Application Priority Data
Mar. 18, 2004 (GB) 0406141.2

(51) Int. Cl. B01D 61/44; B01D 61/46

(52) U.S. Cl. 204/522; 204/630; 204/632; 204/539

(57) ABSTRACT

Apparatus is described for removing ionisable impurities from an electrolyte solution in an electromembrane device. The apparatus comprises means for recirculating the electrolyte solution between the cathode and the anode, and means for transferring selected ions from the electrolyte solution into a separate stream upon application of a current.

### CROSS REFERENCE TO RELATED APPLICATIONS

This application claims the benefit of PCT Patent Application PCT/GB2005/000875 with International Filing Date of 9 Mar. 2005, which claims priority from British Patent Application 0406141.2, filed 18 Mar. 2004, which is incorporated by reference herein.

### BACKGROUND OF THE INVENTION

This invention relates to an electromembrane process and apparatus, and in particular to such a process and apparatus in which removal of ionisable species from the electrolyte stream is enabled.

In the prior art, electromembrane processes such as electrodeionisation and electrodialysis are well known. In such processes a feed liquor is desalinated with the ionic content being moved to a low volume, high concentration liquor. These processes find application in industry, for example in the treatment of aqueous wastes generated by the chemical industry and the microelectronics and semiconductor industries.

In some processes, the electrolyte in which the electrodes are bathed can be the concentrated liquor itself, however, where the process involves the treatment of a feed liquor containing ions that can cause damage to the apparatus it is more usual for the electrodes to be separated from the concentrate stream by membranes which prevent passage of ions from and into the electrolyte. Anion exchange membranes, cation exchange membranes, bipolar ion exchange membranes and porous membranes can all be used.

For example, fluoride is generated as a by-product of the semi-conductor device manufacturing industry which produces aqueous hydrofluoric acid as a result of reaction followed by dissolution in a gas scrubbing plant. Such liquids may advantageously be treated by electromembrane processes, using apparatus in which the electrodes are separated from the damaging solutions by membranes. Although this technique substantially prevents movement of ions into the electrolyte, unfortunately it does not solve the problem of electrode damage completely because species, such as the said hydrofluoric acid can still get into the electrolyte, by passage through the membranes as well as by leakage around seals.

In the above described system for treatment of a feed containing hydrofluoric acid, the concentrate solution will contain very high concentrations of that acid. It has been found in practice that movement of HF into the electrolyte does occur, to the extent that HF concentration in the electrolyte can rise to several thousand ppm within a few days, and in these conditions most conventional anode materials will rapidly dissolve.

Solutions to this problem which have been proposed are the use of materials which are resistant to the damaging effects of these ions, such as for example the use of platinum for electrodes and in particular anodes, or the addition of a strong base such as potassium hydroxide to maintain the electrolyte basic or agents to complex the fluoride ions. However to date, no economically viable anode materials have been found that are stable in hydrofluoric acid bearing solutions, and the addition of sufficient quantities of chemicals such as strong bases is also deemed to be either prohibitively expensive or undesirable from the contamination viewpoint.

### BRIEF SUMMARY OF THE INVENTION

It is an object of the present invention to seek to mitigate problems such as this.

According to the invention there is provided apparatus for removing ionisable impurities from an electrolyte solution in an electromembrane device, comprising means for conveying at least one stream of electrolyte solution between a cathode and an anode of the device, and means for transferring selected ions from the electrolyte solution into a separate stream upon application of a current.

The invention thus provides a convenient method for removal of impurities from the electrolyte solution which requires very little modification of existing electromembrane devices and which is economically advantageous in that it does not require the use of expensive electrode materials, and does not require addition of substances to the electrolyte solution.

A first stream of electrolyte solution may be conveyed between the cathode and the anode in contact with the cathode, and a second stream of electrolyte solution may be conveyed between the cathode and the anode in contact with the anode. These two streams may be joined to form a loop, so that the electrolyte solution is recirculated between the cathode and the anode. Alternatively, each of the first and second streams may be separately recirculated in a respective loop. By virtue of recirculating the electrolyte solution, the apparatus does not use large quantities of solution. Therefore, this aspect of the present invention also provides apparatus for removing ionisable impurities from an electrolyte solution in an electromembrane device, comprising means for recirculating electrolyte solution between the cathode and the anode, and means for transferring selected ions from the electrolyte solution into a separate stream upon application of a current

As will be appreciated, the term “impurities” as used herein is intended to mean any ionisable species in the electrolyte solution which is not present by intention.

The means for transferring selected ions may comprise an anion exchange membrane adjacent the cathode and/or a cation exchange membrane adjacent the anode. Such membranes are widely available. In particular, each said membrane may be in direct contact with an electrode. This provides for proper ionic conduction to occur.

As an alternative, each said membrane may be in electrochemical contact with an electrode by means of a liquid permeable ion conducting material. The liquid permeable ion conducting material may suitably comprise one or more selected from an ion exchange resin, ion exchange fibres and an ion exchange foam. In one preferred arrangement, there may be a liquid permeable anion conducting material in contact with the cathode and a liquid permeable cation conducting material in contact with the anode. The thickness of the ion conducting material can be adjusted from many centimetres to zero, the latter being referred to as a zero gap system.

In one particular arrangement, the ion transfer means for transferring selected ions from the electrolyte solution to the separate stream can be adapted to transfer anions only, and in another arrangement the ion transfer means for transferring selected ions from the electrolyte solution to the separate stream can be adapted to transfer cations only. Alternatively, and in a particularly preferred arrangement the ion transfer means for transferring selected ions from the electrolyte solution to the separate stream is adapted to transfer both cations and anions.

The selected ions may conveniently be transferred into a concentrate stream of the electromembrane device. The said concentrate stream may be a concentrate stream containing ions removed from a feed liquor by the electromembrane device.

The electrolyte solution is herein defined as a solution that bathes or contacts an electrode, and may comprise any solution, including, but not limited to, distilled or deionised water.

According to a second aspect of the invention, there is provided an electromembrane device, including apparatus as hereinabove defined. The electromembrane device may, for example, be an electrodeionisation and/or electrodialysis device, which may itself be part of a liquid waste treatment system. The apparatus finds particular utility in an electromembrane device which is a part of a waste fluoride treatment system.

According to a third aspect of the invention there is provided a process for removing ionisable impurities from an electrolyte solution in an electromembrane device, comprising providing means adapted to transfer selected ions from the electrolyte solution to a separate stream on application of a current to the device, conveying at least one stream of electrolyte solution between an anode and a cathode of the device, and applying a said current.

The process may include the step of providing means adapted to transfer anions only, or cations only, or as is particularly, preferred, both anions and cations.

It is particularly convenient for the process to include the step of transferring the selected ions to a concentrate stream of the electromembrane device.

The process may also include the step of recirculating a single stream of electrolyte solution. The solution may comprise an aqueous solution including either deionised or distilled water.

According to a fourth aspect of the invention there is provided an electromembrane process, including the step of operating a process for removing ionisable impurities from an electrolyte solution of an electromembrane device, as set out hereinabove.

The electromembrane process may for example be an electrodeionisation and/or electrodialysis process, which may itself be part of a liquid waste treatment process. The said liquid waste treatment process may be a waste fluoride treatment process.

Features described above in relation to apparatus aspects of the invention are equally applicable to process aspects, and vice versa.

### BRIEF DESCRIPTION OF THE DRAWINGS

The invention will further be described by way of example, with reference to the accompanying drawings, in which,

FIG. 1 is a schematic illustration of apparatus according to the prior art;

FIG. 2 is a schematic illustration of apparatus according to one embodiment of the invention;

FIG. 3 is a schematic illustration of a further embodiment of apparatus according to the invention;

FIG. 4 is a schematic illustration of a still further embodiment of apparatus according to the invention; and

FIG. 5 is a schematic illustration of a yet further embodiment of apparatus according to the invention.

### DETAILED DESCRIPTION OF THE INVENTION

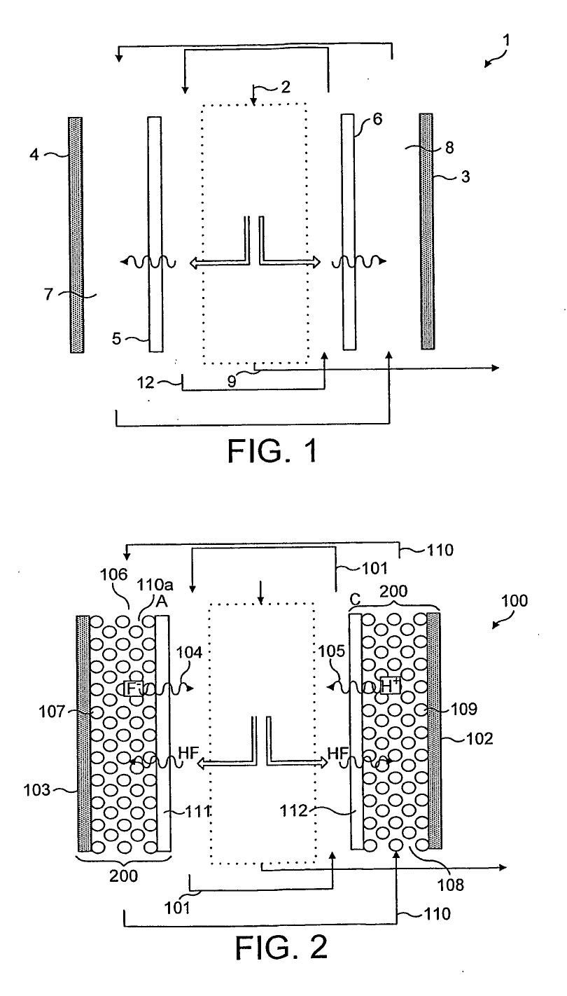

Referring first to FIG. 1, apparatus 1 is a prior art device used for electromembrane treatment of a liquid stream. A raw feed is fed into the apparatus 1 at inlet 2, where it passes into an electrodialysis (ED) or electrodeionisation type (EDI) stack located between anode 3 and cathode 4. These are conventional devices known to the skilled person which will not be described in more detail here. The concentrated liquor produced by the ED/EDI stack circulating in concentrate stream 12 is prevented from contacting the electrodes by ion exchange membranes 5 and 6 which define respectively a cathode compartment 7 and an anode compartment 8. An electrolyte is recirculated between the compartments 7 and 8, the concentrate is recirculated around the ED/EDI stack in the stream 12, and the treated feed exits the apparatus 1 at outlet 9.

The apparatus 1 is illustrated in use in the treatment of a raw feed containing HF. As shown in the drawing, although H⁺ and F⁻ ions are drawn out of the feed liquor into the concentrate as it passes through the ED/EDI stack, HF from the concentrate passes into the electrode compartments 7, 8 by movement through the membranes and leakage around seals in which the membranes are potted. The resulting F⁻ ions in the electrode compartments 7, 8 will quickly cause dissolution of the anode and the cathode.

Referring now to FIG. 2 there is illustrated apparatus 100 for removing ionisable impurities from the electrolyte solution 110a of an electromembrane device 200, comprising means 110 for recirculating a stream of electrolyte solution between the cathode 103 and the anode 102, and means 104, 105 for transferring selected ions from the electrolyte solution into a separate stream 101 upon application of a current.

As will be appreciated, the apparatus 100 is similar to the apparatus 1 except that the membrane 111 defining the cathode compartment 106 is specifically an anion exchange membrane, and the cathode compartment 106 is filled with an anion exchange resin 107 which is in direct contact with both the cathode and the membrane 111. Together the membrane 111 and the resin 107 provide part of the said ion transfer means 104 in this embodiment of the invention. Similarly, the membrane 112 defining the anode compartment 108 is a cation exchange membrane and the anode compartment 108 is filled with a cation exchange resin 109 which is in direct contact with both the anode and the membrane 112. Together the membrane 112 and the resin 109 provide part of the said ion transfer means in this embodiment of the invention. The electrode solution in the compartments 106,108 is preferably distilled water, and in this arrangement is recirculated between the compartments. Alternatively, one stream of electrolyte solution may be conveyed within the cathode compartment 106 in contact with the cathode 103, and another stream of electrolyte solution may be conveyed within the anode compartment 108 in contact with anode 102. These two streams of electrolyte solution may be separately recirculated, or, as illustrated in FIG. 2, linked to form a single, continuous looped stream.

As will be appreciated, the electrolyte solution in this apparatus does not perform the function of an electrolyte, and a significant proportion of the current is being carried by ions in the resin.

The apparatus 100 is also illustrated in use in the treatment of a raw feed containing HF. As before, HF from the concentrate stream 101 passes into the electrolyte solution in the electrode compartments 106, 108. However, the applied current which drives the electrodialysis/electrodeionisation now generates an anionic transfer from the catholyte back into the concentrate stream 101, and a cationic transfer from the anolyte back into the concentrate stream 101 via the anion and cation exchange media 104, 105. Thus, it will be understood that the compartments 106, 108 are acting to sequentially deionise the electrolyte solution, thereby protecting the electrodes from damage.

In both of these examples the compartment that contains the concentrate solution can be replaced by a compartment through which the feed solution is passed.

Suitable ion conducting materials for use with the invention are well known to those skilled in the art of ion exchange and will include, but not be limited to, ion exchange materials such as those listed in table 1.

TABLE 1

| Manufacturer | Name | Type |
|---|---|---|
| Rohm and Haas | IR120 cation resin | Strong acid resin beads. |
| | IRA400 anion resin | Strong base resin beads. |
| | IRA96 anion resin | Weak base resin beads. |
| | IRC50 cation resin | Weak acid resin beads. |
| Dupont | Nafion SAC-13 resin | Strong acid resin granules. |
| Purolite | C100 cation resin | Strong acid resin beads. |
| | A100 anion resin | Strong base resin beads. |
| | S930 resin | Chelating resin beads. |
| Reilley Industries | Reillex HPQ resin | Strong base resin beads. |
| | Reillex HP | Weak base resin beads. |
| Toray | Ionex | Both strong base anion and |
| | | strong acid cation resin fibres |
| Smoptech | Smopex | Both strong base anion and |
| | | strong acid cation resin fibres |
| | | and mats. |

An experiment was set up to measure the HF concentration in the electrolyte of the apparatus 100 shown in FIG. 2. The electrochemical cell comprised two platinum electrodes. The electrolyte solution was deionised water. The concentrate solution contained 15000 ppm hydrofluoric acid. IRA400 resin beads in the hydroxide form were used to contact the cathode with a CMX cation membrane (ex. Tokuyama Soda). The resin layer had a thickness of 10 mm. IR120 resin beads in the hydrogen form were used to contact the anode with an AMX anion membrane (ex. Tokuyama Soda). The resin layer had a thickness of 10 mm. The electrodes and the exposed membranes had an area of 6 cm².

### Results

The HF concentration in the electrolyte solution remained around 2 ppm for the duration of the test which lasted seven days, and even returned to 2 ppm within hours of the HF concentration in the electrolyte being deliberately raised to 6000 ppm.

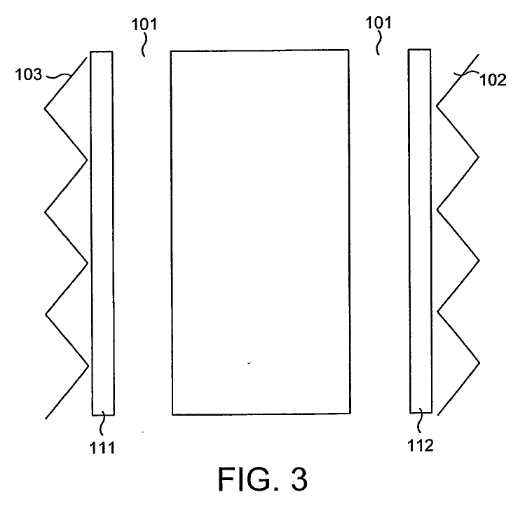

Referring now to FIG. 3, there is illustrated a modified form of the invention from which the resins 107, 109 have been omitted and the membranes 111, 112 are sited in contact with the electrodes. Thus, in this embodiment of the invention the membranes 111, 112 provide the anion and cation transfer media 104, 105 required for transfer of ions into the concentrate stream 101. In this zero-gap system the electrodes are grids or meshes bathed with the electrolyte solution, which is again either recirculated between the compartments, or separately recirculated.

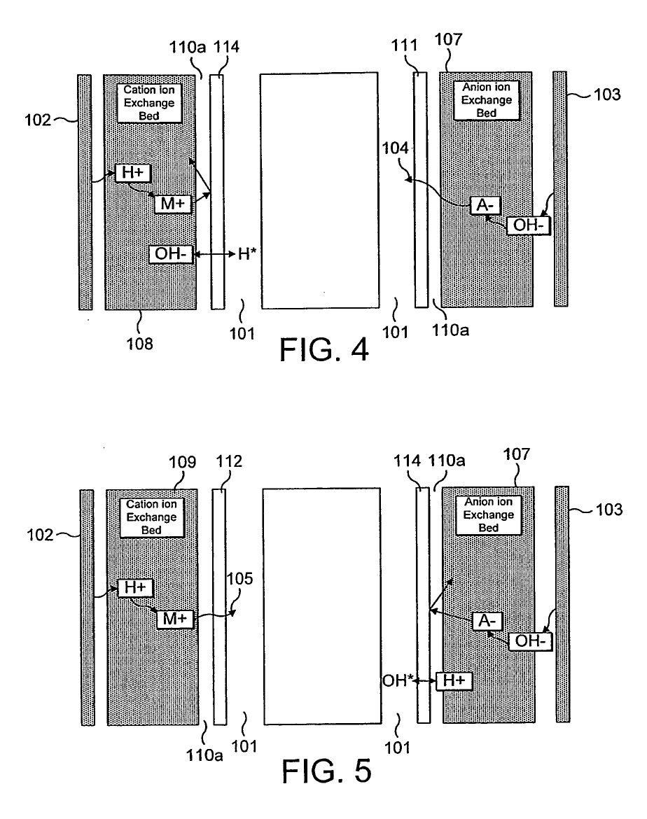

Referring now to FIG. 4, there is illustrated a further embodiment of apparatus according to the invention. From this schematic the skilled worker will appreciate that if the cation membrane 112 is replaced with a bipolar membrane 114 this membrane 114 will prevent cations moving from the electrolyte solution, resulting in a water splitting reaction, as illustrated. In this case, the combination of the anion exchange resin 107 and anion selective membrane 111 only will remove impurity ions from the electrolyte. FIG. 5 illustrates the reverse case. It will be appreciated that the embodiments of FIGS. 4 and 5 can be modified by removal of the resins, as described above and illustrated in FIG. 3.

As the skilled worker will appreciate, the process and apparatus of the invention can be used to remove many different impurities from the electrolyte solution in an electromembrane device and therefore finds application in a large number of industries, but in particular in liquid waste treatment industries. Removal of impurities can be desirable because of their deleterious effects upon the apparatus as described in the above example, or also because the impurities themselves are of high value commercially.

Examples of deleterious anions are fluoride, which is corrosive and chloride, sulphate and chromite which are corrosive and which can be oxidised to species that attack the ion exchange membranes. Examples of cations that would be deleterious are cations that plate on the cathode, such as copper ions, which plate as copper metal, the copper metal causing damage by growing into the membrane, and cations that plate onto the anode as oxide type species such as manganese and lead oxides which also grow into the membrane and cause damage.

Examples of high value anions are carboxylic acids (where the total molecular size does not prevent movement of the R—COO— anion through the anionic membrane, and other organic acids such as phosphonic, sulphonic, arsenic, phenates and amino acids. Examples of high value cations are amines, amides and amino acids.

1. Apparatus for removing ionisable impurities from an electrolyte solution in an electromembrane device, comprising means for conveying at least one stream of electrolyte solution between a cathode and an anode of the device, and means for transferring selected ions from the electrolyte solution into a separate stream upon application of a current.

2. Apparatus according to claim 1, wherein the means for transferring selected ions comprises an anion exchange membrane adjacent the cathode and/or a cation exchange membrane adjacent the anode.

3. Apparatus according to claim 2, wherein each said membrane is in contact with an electrode.

4. Apparatus according to claim 2, wherein each said membrane is in electrical contact with an electrode by means of a liquid permeable ion conducting material.

5. Apparatus according to claim 4, wherein the liquid permeable ion conducting material comprises one or more selected from an ion exchange resin, ion exchange fibres and an ion exchange foam.

6. Apparatus according to claim 5, there being a liquid permeable anion conducting material in contact with the cathode and a liquid permeable cation conducting material in contact with the anode.

7. Apparatus according to any preceding claim, wherein the ion transfer means for transferring selected ions from the electrolyte solution to the separate stream is adapted to transfer anions only.

8. Apparatus according to any of claims 1 to 6, wherein the ion transfer means for transferring selected ions from the electrolyte solution to the separate stream is adapted to transfer cations only.

9. Apparatus according to any of claims 1 to 6, wherein the ion transfer means for transferring selected ions from the electrolyte solution to the separate stream is adapted to transfer both cations and anions.

10. Apparatus according to any preceding claim, wherein the selected ions are transferred into a concentrate stream.

11. Apparatus according to claim 10, wherein the concentrate stream contains ions removed from a feed liquor by the electromembrane device.

12. Apparatus according to any preceding claim, wherein the electrolyte solution comprises distilled water.

13. Apparatus according to any preceding claim, wherein the means for conveying at least one stream of electrolyte solution comprises means for conveying a first stream between the cathode and the anode in contact with the cathode, and means for conveying a second stream between the cathode and the anode in contact with the anode.

14. Apparatus according to any preceding claim, wherein the means for conveying at least one stream of electrolyte solution comprises means for recirculating the electrolyte solution between the cathode and the anode.

15. An electromembrane device, including apparatus according to any preceding claim.

16. An electromembrane device according to claim 15, being an electrodeionisation and/or electrodialysis device.

17. An electromembrane device according to claim 15 or claim 16, being part of a liquid waste treatment system.

18. An electromembrane device according to any of claims 15 to 17, being part of a waste fluoride treatment system.

19. A process for removing ionisable impurities from an electrolyte solution in an electromembrane device, comprising providing means adapted to transfer selected ions from the electrolyte solution to a separate stream on application of a current to the device, conveying at least one stream of electrolyte solution between an anode and a cathode of the device, and applying a said current.

20. A process according to claim 19, including the step of providing means adapted to transfer anions only.

21. A process according to claim 19, including the step of providing means adapted to transfer cations only.

22. A process according to claim 19, including the step of providing means adapted to transfer both anions and cations.

23. A process according to any of claims 19 to 22, including the step of transferring the selected ions to a concentrate stream of the electromembrane device.

24. A process according to any of claims 19 to 23, including the step of conveying between the anode and the cathode at least one stream of electrolyte solution comprising distilled water.

25. A process according to any of claims 19 to 24, wherein the electrolyte solution is recirculated between the cathode and the anode.

26. An electromembrane process, including the step of operating a process according to any of claims 19 to 25.

27. An electromembrane process according to claim 26, being an electrodeionisation and/or electrodialysis process.

28. An electromembrane process according to claim 26 or claim 27, being part of a liquid waste treatment process.

29. An electromembrane process according to any of claims 26 to 28, being part of a waste fluoride treatment process
